(19) United States
(12) Patent Application Publication
(10) Pub. No.: US 2007/0175201 A1
(43) Pub. Date: Aug. 2, 2007

(54) Power system

(75) Inventors: James John Callas, Peoria, IL (US); Cody Patrick Renshaw, Peoria, IL (US); Brian Cole Howson, Peoria, IL (US); Kevin Lee Martin, Washbum, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/342,618

(22) Filed: Jan. 31, 2006

(51) Int. Cl. F02C 3/14

(52) U.S. Cl. 60/39.35

(57) ABSTRACT

A power system includes a rotary compressor. The power system may also include one or more power sources drivingly connected to the rotary compressor, the one or more power sources not including a turbine. Additionally, the power system may include a turbine, the turbine being free to rotate independently of the rotary compressor. The power system may also include power-system controls operable to cause the rotary compressor to generate a gas flow by causing the one or more power sources to rotate the rotary compressor. Additionally, the power system may be operable to direct at least a portion of the gas flow generated by the rotary compressor through the turbine to rotate the turbine.

### TECHNICAL FIELD

The present disclosure relates to power systems and, more particularly, to power systems having a gas-turbine system.

### BACKGROUND

Many machines include power systems having a gas-turbine system configured to provide power for various tasks. Many gas-turbine systems include a rotary compressor and a turbine drivingly connected to one another. During operation of such a gas-turbine system, the rotary compressor and turbine rotate together. As it rotates, the rotary compressor creates a gas flow. Such gas-turbine systems generally produce the power to rotate the turbine, the rotary compressor, and any other components drivingly connected to the turbine by combusting fuel with the gas flow from the rotary compressor and directing the gas flow through the turbine. Some gas-turbine systems, which are sometimes referred to as “two-shaft” gas-turbine systems, include an additional turbine that is mechanically decoupled from the rotary compressors. Such “two-shaft” gas-turbine systems typically power the additional turbine by directing at least a portion of the gas flow from the rotary compressor through the. additional turbine.

During operation of a gas-turbine system, the desirable flow rate of the gas flow generated by the rotary compressor may depend upon the power output required of the gas-turbine system and/or various other operating conditions. Accordingly, many gas-turbine systems are configured to respond to changing operating conditions by adjusting the rotation speed of the rotary compressor to adjust the flow rate of the gas flow generated by the rotary compressor. For example, gas-turbine systems that utilize a turbine to rotate the rotary compressor may adjust the rotation speed of the rotary compressor by adjusting the percentage of the gas flow directed through the turbine and/or the rate at which fuel is combusted with the gas flow before the gas flow is directed through the turbine. Unfortunately, such methods may produce sluggish and/or unpredictable changes in the rotation speed of the rotary compressor and the gas flow generated thereby. As a result, gas-turbine systems that employ a turbine to rotate the rotary compressor may provide compromised performance when operating conditions change.

Published International Patent Application No. WO 03/025370 by Malmrup (“the '370 application”) shows a power system that selectively drives a rotary compressor of a gas-turbine system with a motor/generator. In the gas-turbine system of the '370 application, a rotary compressor and a first turbine are commonly mounted on a first high-speed shaft. A first motor/generator is drivingly connected to the first high-speed shaft. The gas-turbine system further includes a combustion chamber disposed between the rotary compressor and the first turbine. Additionally, the gas-turbine system of the '370 application includes a second turbine and a third turbine commonly mounted on a second high-speed shaft. Dependent upon circumstances, the power-system of the '370 application rotates the rotary compressor with the first motor/generator by itself, the first turbine by itself, or with both the first motor/generator and the first turbine.

Although the power system of the '370 application utilizes a motor/generator to drive the rotary compressor of the gas-turbine system, certain disadvantages persist. For example, selectively utilizing the first turbine by itself to drive the rotary compressor may compromise control over the rotation speed of the rotary compressor and the flow rate of the gas flow generated by the rotary compressor. Additionally, providing both a motor/generator and a turbine for driving a rotary compressor of a gas-turbine system may entail unnecessary expense.

The power system of the present disclosure solves one or more of the problems set forth above.

### SUMMARY OF THE INVENTION

One disclosed embodiment relates to a power system having a rotary compressor. The power system may also include one or more power sources drivingly connected to the rotary compressor, the one or more power sources not including a turbine. Additionally, the power system may include a turbine, the turbine being free to rotate independently of the rotary compressor. The power system may also include power-system controls operable to cause the rotary compressor to generate a gas flow by causing the one or more power sources to rotate the rotary compressor. Additionally, the power system may be operable to direct at least a portion of the gas flow generated by the rotary compressor through the turbine to rotate the turbine.

Another embodiment relates to a method of operating a power system having a rotary compressor and a turbine, the turbine being free to rotate independently of the rotary compressor. The method may include selectively generating a gas flow with the rotary compressor by rotating the rotary compressor with one or more power sources, the one or more power sources including one or more power sources that are not turbines. Additionally, the method may include controlling the rotation speed of the rotary compressor exclusively with the one or more power sources that are not turbines. The method may also include directing at least a portion of the gas flow generated with the rotary compressor through the turbine to rotate the turbine.

### BRIEF DESCRIPTION OF THE DRAWINGS

FIG. 1 is a schematic illustration of a first embodiment of a machine according to the present disclosure.

### DETAILED DESCRIPTION

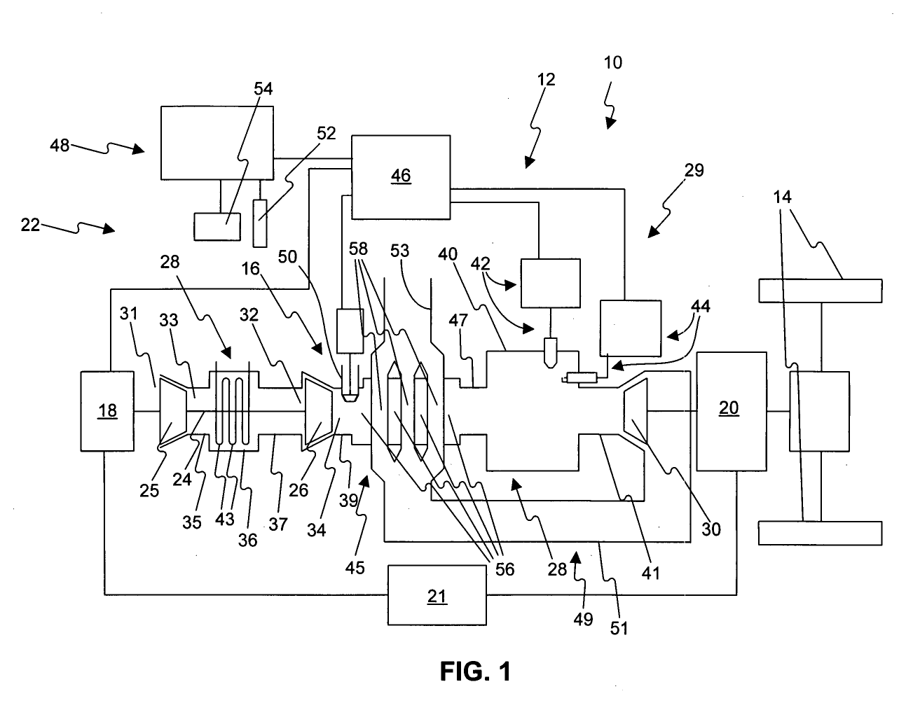

FIG. 1 illustrates one embodiment of a machine 10 having a power system 12 according to the present disclosure. Machine 10 may be a mobile machine having one or more propulsion devices 14 in addition to power system 12. Power system 12 may include a gas-turbine system 16, a power source 18, a power-conversion device 20, an energy-storage device 21, and power-system controls 22.

Gas-turbine system 16 may include a rotary member 24, a rotary compressor 25, a rotary compressor 26, a gas-transfer system 28, a combustion system 29, a turbine 30, and an exhaust system 49. Rotary compressors 25, 26 may be drivingly connected to rotary member 24. Each rotary compressor 25, 26 may be any type of component configured to create a gas flow when rotating. For example, each rotary compressor 25, 26 may be configured to drive gas from an inlet area 31, 32 to an outlet area 33, 34 when rotating. The outlet area 33, 34 of a rotary compressor 25, 26 may be axially and/or radially spaced from the inlet area 31, 32 of that rotary compressor 25, 26. Each rotary compressor 25, 26 may include various types of devices for moving gas from its inlet area 31, 33 to its outlet area 32, 34. For example, rotary compressor 25, 26 may each include a plurality of fins (not shown) configured to accelerate gas radially and/or axially when rotary compressors 25, 26 rotate.

Gas-transfer system 28 may include various devices for transferring gas between rotary compressors 25, 26 and turbine 30. Gas-transfer system 28 may include a passage 35, a gas cooler 36, and a passage 37 for transferring gas from outlet area 33 of rotary compressor 25 to inlet area 32 of rotary compressor 26. Gas cooler 36 may be configured to cool gas as it flows therethrough. For example, gas cooler 36 may include cooling coils 43 that gas flows across as the gas flows through gas cooler 36. In addition to passage 35, gas cooler 36, and passage 37, gas-transfer system 28 may include a passage 39, a charge-gas side 56 of a recuperator 45, a passage 47, a combustion chamber 40, and a passage 41 for directing gas from outlet area 34 of rotary compressor 26 to turbine 30. Charge-gas side 56 of recuperator 45 may include one or more passages through which gas may flow on its way from outlet area 34 of rotary compressor 26 to turbine 30.

Combustion system 29 may be configured to combust fuel, such as liquid, gaseous, or particulate hydrocarbon fuel, with the gas flowing through gas-transfer system 28. Combustion system 29 may include combustion chamber 40 and a fuel-supply system 42 configured to deliver fuel into combustion chamber 40. Additionally, in some embodiments, combustion system 29 may include a fuel-ignition system 44 for igniting fuel and gas in combustion chamber 40.

Turbine 30 may be any type of device configured to be rotated by the gas flow received from gas-transfer system 28. For example, turbine 30 may be a rotary member having a plurality of fins (not shown) configured and arranged in such a manner that gas flowing radially and/or axially through turbine 30 impinges upon the fins and creates a torque on turbine 30. As FIG. 1 shows, turbine 30 may be mechanically decoupled from rotary compressors 25, 26, such that turbine 30 may be free to rotate independently of rotary compressors 25, 26.

Exhaust system 49 may be configured to direct gas that has flowed through turbine 30 to the atmosphere. Exhaust system 49 may include a passage 51, an exhaust-gas side 58 of recuperator 45, and a passage 53. Recuperator 45 may be configured to transfer heat from gas flowing through exhaust-gas side 58 to gas flowing through charge-gas side 56. For example, as FIG. 1 shows, one or more of the passages of the exhaust-gas side 58 may have walls that adjoin one or more of the passages of the charge-gas side 56, so that heat may readily transfer from the gas in exhaust-gas side 58, to the gas in charge-gas side 56, through the adjoining walls.

Gas-turbine system 16 is not limited to the configuration shown in FIG. 1. For example, in some embodiments, gas-turbine system 16 may omit rotary compressor 25, passage 35, gas cooler 36, and passage 37. Additionally, gas-turbine system 16 may include one or more additional turbines drivingly connected to turbine 30 and/or one or more additional turbines mechanically decoupled from turbine 30 and rotary compressors 25, 26. Furthermore, combustion system 29 may be configured differently than FIG. 1 shows. For example, combustion system 29 may be configured to combust fuel with a reactant other than the gas flow generated by rotary compressors 25, 26. In such embodiments, gas-turbine system 16 may include provisions for transferring at least some of the heat generated by combustion system 29 to the gas flow generated by rotary compressors 25, 26. Additionally, gas-turbine system 16 may omit combustion system 29. Some embodiments of gas-turbine system 16 may have provisions other than combustion system 29 for increasing the energy of the gas flow generated by rotary compressors 25, 26.

Power source 18 may be drivingly connected to rotary member 24 and rotary compressors 25, 26. Power source 18 may include various types of components configured to rotate rotary member 24 and rotary compressors 25, 26. For example, in some embodiments, power source 18 may be an electric machine configured to operate as an electric motor and/or an electric generator. Additionally, in some embodiments power source 18 may be a fluid-driven motor or combination fluid pump/fluid-driven motor.

Power-conversion device 20 may be drivingly connected to turbine 30 and propulsion devices 14. Power-conversion device 20 may be any type of component configured to mechanically draw power from turbine 30 and/or propulsion devices 14 and convert at least a portion of that power into another form. For example, in some embodiments, power-conversion device 20 may be an electric machine operable to mechanically draw power from turbine 30 and/or propulsion devices 14 and convert at least a portion of that power into electricity. In some embodiments, power-conversion device 20 may be operable as both an electric generator and an electric motor. Alternatively, power-conversion device 20 may be a fluid pump configured to mechanically draw power from turbine 30 and/or propulsion devices 14 and pump fluid. In some embodiments, power-conversion device 20 may be a combination fluid pump/fluid-powered motor.

Energy-storage device 21 may be any type of device configured to receive energy from power-conversion device 20, power source 18, and/or other components of machine 10 and store that energy for later use by various components of machine 10. For example, in embodiments where power source 18 and power-conversion device 20 are electric machines, energy storage device 21 may be an electrical battery or capacitor electrically connected to power source 18 and power-conversion device 20. Alternatively, in embodiments where power source 18 is a fluid-powered motor and power-conversion device 20 is a fluid pump, energy-storage device 21 may be a reservoir or hydraulic accumulator. In such embodiments, various fluid-transfer components, such as conduits and valves may connect energy-storage device 21 to power source 18 and power-conversion device 20.

Power-system controls 22 may be configured to control one or more aspects of the operation of power system 12. Power-system controls 22 may include a controller 46, operator controls 48, and a diversion valve 50. Controller 46 may include one or more processors (not shown) and/or one or more memory devices (not shown). Controller 46 may be operatively connected to various components of machine 10. For example, as FIG. 1 shows, controller 46 may be operatively connected to power source 18, power-conversion device 20, fuel-supply system 42, fuel-ignition system 44, operator controls 48, and diversion valve 50. Additionally, controller 46 may be operatively connected to various other sensors (not shown), controllers (not shown), and/or other types of devices (not shown) of machine 10.

Operator controls 48 may include various components for receiving inputs from an operator and transmitting those inputs to various other components of machine 10. For example, operator controls 48 may include an accelerator 52 for receiving acceleration requests from an operator, a brake pedal 54 for receiving braking requests from an operator, and various components for transmitting such acceleration and braking requests to controller 46.

Diversion valve 50 may be operable to selectively divert some of the gas flow generated by rotary compressors 25, 26 from flowing across turbine 30. For example, diversion valve 50 may be disposed in a wall of passage 39 so that opening diversion valve 50 allows gas to flow from passage 39 to the atmosphere without flowing to turbine 30.

Propulsion devices 14 may include any types of devices configured to propel machine 10 by applying power from power system 12 to the environment surrounding machine 10. As FIG. 1 shows, propulsion devices 14 may be drivingly connected to turbine 30 and power-conversion device 20. Propulsion devices 14 may include ground-engaging propulsion devices, such as wheels or track units, configured to propel machine 10 by transferring power from turbine 30 and/or power-conversion device 20 to the ground. Additionally, in some embodiments, propulsion devices 14 may include one or more devices, such as one or more propellers, configured to receive power from turbine 30 and/or power-conversion device 20 and move fluid to propel machine 10. Furthermore, in some embodiments, power-system 12 may be configured to utilize some or all of the gas flow generated by rotary compressors 25, 26 to provide thrust for propelling machine 10, such that rotary compressors 25, 26 may also constitute propulsion devices.

Machine 10 and power system 12 are not limited to the configurations shown in FIG. 1. For example, power system 12 may include various additional power sources and/or power-conversion devices drivingly connected to turbine 30. Similarly, power system 12 may include various other power sources drivingly connected to rotary compressors 25, 26. Additionally, while FIG. 1 shows power source 18 and power-conversion device 20 operatively connected to one another only through energy-storage device 21, power source 18 and power-conversion device 20 may be operatively connected through other paths. Furthermore, power system 12 may include various other power sources and/or power-consuming devices operatively connected to the components of machine 10 shown in FIG. 1.

Additionally, power system 12 may include additional power-transfer components drivingly connecting the various power-producing and power-consuming devices of power system 12. In some embodiments, power-system 12 may include belts and pulleys, gears, chains, flexible couplers, variable-slip couplers, fluid couplers, transmissions, and/or other power-transfer components drivingly connecting power source 18 and rotary compressors 25, 26. Additionally, in some embodiments, power system 12 may include similar components drivingly connecting two or more of turbine 30, power-conversion device 20, and propulsion devices 14. Additionally, in some embodiments, power-system controls 22 may be operable to selectively decouple various components. For example, power-system controls 22 may be operable to selectively decouple power source 18 and rotary compressors 25, 26 and/or power-system controls 22 may be operable to selectively decouple two or more of turbine 30, power-conversion device 20, and propulsion devices 14.

Machine 10 may also omit various components shown in FIG. 1. For example, power system 12 may omit one or both of power-conversion device 20 and energy-storage device 21. Additionally, machine 10 may omit propulsion devices 14.

### INDUSTRIAL APPLICABILITY

Machine 10 may have application wherever power is required for performing one or more tasks. Operation of machine 10 will be described herein below.

During operation of machine 10, power-system controls 22 may receive inputs from various sources and automatically control the components of power system 12 to achieve various objectives. For example, if operator controls 48 transmit an acceleration request from an operator to controller 46, controller 46 may automatically adjust the operation of various components of power-system 12 in order to provide increased power to propulsion devices 14. Similarly, if operator controls 48 transmit a braking request from an operator to controller 46, controller 46 may automatically operate power-system 12 to brake machine 10.

Power-system controls 22 may control the rotation speed of rotary compressors 25, 26 exclusively with power source 18. For example, in embodiments where power source 18 is an electric machine, power-system controls 22 may cause power source 18 to accelerate rotary compressors 25, 26 or resist deceleration of rotary compressors 25, 26 by operating power source 18 as an electric motor. In such embodiments, power-system controls 22 may also selectively operate power source 18 as an electric generator to decelerate rotary compressors 25, 26. Additionally, under some circumstances, power-system controls 22 may cause power source 18 to be inactive, so that rotary compressors 25, 26 may freewheel. In embodiments where power source 18 is another type of device, such as a fluid pump/fluid-powered motor, power-system controls 22 may similarly control the rotation speed of rotary compressors 25, 26 by controlling the amount of power that power source 18 mechanically supplies to or draws from rotary compressors 25, 26.

When power-system controls 22 cause a gas flow through turbine 30 by rotating rotary compressors 25, 26 with power source 18, turbine 30 may rotate and power propulsion devices 14, power-conversion device 20, and/or any other devices drivingly connected to turbine 30. Power-system controls 22 may adjust the amount of power provided by turbine 30 with various components of power system 12. Power-system controls 22 may increase or decrease the power provided by turbine 30 by increasing or decreasing the rotation speed of rotary compressors 25, 26 with power source 18 and, thereby, increasing or decreasing the gas flow through turbine 30. Additionally, power-system controls 22 may adjust the rate of gas flow through turbine 30 and, thus, the power provided by turbine 30 by adjusting whether and/or to what extent diversion valve 50 is open. Furthermore, power-system controls 22 may increase or decrease the power provided by turbine 30 by increasing or decreasing the rate at which combustion system 29 combusts fuel with the gas flow generated by rotary compressors 25, 26 and, thereby, increasing or decreasing the energy of the gas flowing through turbine 30.

Power-system controls 22 may direct a portion of the power produced by turbine 30 to power source 18 for rotating rotary compressors 25, 26. To do so, power-system controls 22 may cause power-conversion device 22 to mechanically draw power from turbine 30, convert that power into a form useable by power source 18, and direct that power to energy-storage device 21 and, from there, to power source 18. For example, in embodiments where power source 18 and power-conversion device 20 are electric machines, power-system controls 22 may operate power-conversion device 20 as an electric generator supplying electricity to energy-storage device 21, while operating power source 18 as an electric motor drawing electricity from energy-storage device 21. Similarly, in embodiments where power source 18 is a fluid-driven motor and power-conversion device 20 is a fluid pump/fluid-driven motor, power-system controls 22 may cause power-conversion device 20 to pump pressurized fluid to energy-storage device 21, while causing power source 18 to operate on a flow of pressurized fluid from energy-storage device 21.

As mentioned above, power-system controls 22 may also selectively operate power system 12 to brake machine 10. When machine 10 is in motion, power-system controls 22 may selectively operate power-conversion device 20 to brake machine 10 by mechanically drawing power from propulsion devices 14 and providing at least a portion of that power to other components in a different form. For example, in embodiments where power-conversion device 20 is an electric machine, power-system controls 22 may cause power-conversion device 20 to operate as an electric generator mechanically drawing power from propulsion devices 14 and supplying electricity to energy-storage device 21. Similarly, in embodiments where power-conversion device 20 is a fluid pump/fluid-powered motor, power-system controls 22 may cause power-conversion device 20 to brake machine 10 by mechanically drawing power from propulsion devices 14 and using that power to pump fluid to energy-storage device 21.

In some embodiments, in conjunction with operating power-conversion device 20 to brake machine 10, power-system controls 22 may operate gas-turbine system 16 and power source 18 to dissipate power. Simultaneous with operating power-conversion device 20 to brake machine 10, power-system controls 22 may cause power source 18 to dissipate energy by rotating rotary compressors 25, 26. Power-system controls 22 may simultaneously suppress the amount of power produced by turbine 30. For example, power-system controls 22 may cause combustion system 29 to reduce or suspend combustion of fuel in combustion chamber 40. Additionally, in some embodiments, while power-source 18 is dissipating energy by rotating rotary compressors 25, 26, power-system controls 22 may divert some or all of the gas discharged by rotary compressors 25, 26 from flowing through turbine 30. For example, power-system controls 22 may open diversion valve 50 so that gas discharged from rotary compressors 25, 26 may escape passage 39 without traveling to turbine 30.

In some embodiments, power-system controls 22 may operate gas-turbine system 16 and power source 18 to dissipate power whenever power-system controls 22 operate power-conversion device 20 to brake machine 10. In other embodiments, when power-system controls 22 are operating power-conversion device 20 to brake machine 10, power-system controls 22 may selectively operate gas-turbine system 16 and power source 18 to dissipate power, dependent upon various operating conditions of machine 10. For example, in some embodiments, power-system controls 22 may operate gas-turbine system 16 and power source 18 to dissipate energy only when power-conversion device 20 operates to brake machine 10 and energy-storage device 21 has reached its energy storage capacity.

The disclosed embodiments of power system 12 provide various performance and cost benefits. Allowing power-system controls 22 to adjust the rotation speed of rotary compressors 25, 26 independently of the rotation speed of turbine 30 allows power-system controls 22 to adjust the flow rate of gas through turbine 30 independently of the rotation speed of turbine 30. This may facilitate rapid adjustment of the amount of power produced by gas-turbine system 16, desirably high power production by gas-turbine system 16 when turbine 30 is rotating at slow speeds or stopped, and various other performance benefits. Furthermore, controlling the rotation speed of rotary compressors 25, 26 exclusively with one or more power sources other than a turbine may help power-system controls 22 maintain precise control over the rotation speed of rotary compressors 25, 26 and the gas flow rate generated by rotary compressors 25, 26 at all times. Moreover, using one or more other power source to rotate rotary compressors 25, 26, rather than a turbine, saves the cost associated with providing a turbine to rotate rotary compressors 25, 26.

It will be apparent to those skilled in the art that various modifications and variations can be made in the power system and methods without departing from the scope of the disclosure. Other embodiments of the disclosed power system and methods will be apparent to those skilled in the art from consideration of the specification and practice of the power system and methods disclosed herein. It is intended that the specification and examples be considered as exemplary only, with a true scope of the disclosure being indicated by the following claims and their equivalents.

What is claimed is:

1. A power system, comprising:
a rotary compressor;
one or more power sources drivingly connected to the rotary compressor, the one or more power sources not including a turbine;
a turbine, the turbine being free to rotate independently of the rotary compressor;
power-system controls operable to cause the rotary compressor to generate a gas flow by causing the one or more power sources to rotate the rotary compressor; and
the power system being operable to direct at least a portion of the gas flow generated by the rotary compressor through the turbine to rotate the turbine.

2. The power system of claim 1, further including a power-conversion device drivingly connected to the turbine, the power-conversion device being operable to mechanically draw power from the turbine and convert at least a portion of that power into a form useable by one or more of the power sources.

3. The power system of claim 1, wherein:
the one or more power sources include a first electric machine operable as an electric motor; and
the system includes a second electric machine drivingly connected to the turbine, the second electric machine being operable as an electric generator.

4. The power system of claim 3, wherein:
the power system is part of a machine having one or more propulsion devices drivingly connected to the second electric machine;
the power-system controls are further operable to
when the machine is in motion, cause the second electric machine to brake the machine by mechanically drawing power from the one or more propulsion devices and generating electricity; and
while causing the second electric machine to brake the machine, cause the first electric machine to operate as an electric motor to rotate the rotary compressor.

5. The power system of claim 1, wherein:
the power system further includes a power-conversion device;
the power system is part of a machine having one or more propulsion devices drivingly connected to the power-conversion device;
the power-system controls are further operable to
when the machine is in motion, cause the power-conversion device to brake the machine by mechanically drawing power from the one or more propulsion devices and transmitting at least a portion of that power in another form to one or more other components of the power system.

6. The power system of claim 5, wherein the power-system controls are further operable to
while causing the power-conversion device to brake the machine
cause one or more of the one or more power sources to rotate the rotary compressor, and
divert at least a portion of the gas flow generated by the rotary compressor from flowing through the turbine.

7. The power system of claim 1, wherein:
the rotary compressor is a first rotary compressor;
the power system further includes
a second rotary compressor, and
a gas cooler;
the power-system controls are further operable to selectively cause the second rotary compressor to rotate and generate a gas flow; and
the power system is operable to direct at least a portion of the gas flow generated by the second rotary compressor through the gas cooler to the first rotary compressor.

8. A method of operating a power system having a rotary compressor and a turbine, the turbine being free to rotate independently of the rotary compressor, the method including:
selectively generating a gas flow with the rotary compressor by rotating the rotary compressor with one or more power sources, the one or more power sources including one or more power sources that are not turbines;
controlling the rotation speed of the rotary compressor exclusively with the one or more power sources that are not turbines; and
directing at least a portion of the gas flow generated with the rotary compressor through the turbine to rotate the turbine.

9. The method of claim 8, wherein controlling the rotation speed of the rotary compressor exclusively with the one or more power sources that are not turbines includes controlling the rotation speed of the turbine exclusively with at least one electric machine that is operable as an electric motor.

10. The method of claim 8, wherein:
the power system is part of a machine having one or more propulsion devices; and
the method further includes
when the machine is in motion, causing a power-conversion device drivingly connected to the one or more propulsion devices to brake the machine by mechanically drawing power from the one or more propulsion devices and transmitting at least a portion of that power in another form to one or more other components of the power system.

11. The method of claim 10, wherein:
the power-conversion device is a first electric machine;
causing the power-conversion device to brake the mobile machine includes causing the power-conversion device to mechanically draw power from the one or more propulsion devices and generate electricity utilizing the power mechanically drawn from the one or more propulsion devices; and
selectively rotating the rotary compressor with one or more power sources includes
while causing the power-conversion device to brake the machine by generating electricity, operating a second electric machine drivingly connected to the rotary compressor as an electric motor to rotate the rotary compressor.

12. The method of claim 11, further including:
while causing the first electric machine to brake the mobile machine by generating electricity and operating the second electric machine as an electric motor to rotate the rotary compressor, diverting at least a portion of the gas flow generated by the rotary compressor from flowing through the turbine.

13. The method of claim 8, further including:
mechanically drawing power from the turbine;
converting at least a portion of the power mechanically drawn from the turbine into a form useable by one or more of the one or more power sources drivingly connected to the rotary compressor; and
directing at least a portion of the converted power to one or more of the one or more power sources drivingly connected to the rotary compressor.
